(19) United States
(12) Patent Application Publication
(10) Pub. No.: US 2013/0338844 A1
(43) Pub. Date: Dec. 19, 2013

(54) INTELLIGENT POWER STRIP

(71) Applicants: Kai Chuen CHAN, Kowloon (HK); Hsin Wu FONG, Tai Po (HK)

(72) Inventors: Kai Chuen CHAN, Kowloon (HK); Hsin Wu FONG, Tai Po (HK)

(73) Assignee: Vision Green Limited

(21) Appl. No.: 13/826,518

(22) Filed: Mar. 14, 2013

Related U.S. Application Data
(60) Provisional application No. 61/661,054, filed on Jun. 18, 2012.

(51) Int. Cl. G05B 13/02

(52) U.S. Cl. CPC G05B 13/02
USPC 700/295; 700/286; 700/298

(57) ABSTRACT

An apparatus for monitoring power comprises a plurality of plugs, at least one sensor in communication with the plurality of outlets, and at least one microcontroller unit in communication with the at least one sensor. Each of the plurality of plugs is able to provide electrical power to a device. The at least one sensor is configured to monitor current flowing to the plurality of plugs. The at least one microcontroller unit is configured to receive readings from the at least one sensor regarding the amount of current delivered to the plurality of plugs.

### PRIORITY

This application claims priority to U.S. Provisional Patent Application Ser. No. 61/661,054, filed Jun. 18, 2012, entitled “Intelligent Power Strip,” the disclosure of which is incorporated by reference herein.

### FIELD

Embodiments of the present invention relate, in general, to an intelligent power strip and platform. In particular, the intelligent power strip and platform is used for monitoring and controlling power usage.

### BACKGROUND

Throughout the course of a day, many electronic device devices remain plugged into an outlet without actually being used at all. In fact, during the course of a 24 hour cycle, some electronic devices may only see, for example, two hours of use, while being plugged in for the remaining twenty two hours. However, while an electronic device is plugged into an outlet, the electronic device still draws power despite being in an “off” state. This power drain is often referred to as the leakage power. While this power drain is much smaller in comparison to when the electronic device is in use, over time, the amount of power drain can add up significantly. In some cases, leakage power may amount to as much as 10% of a home's power usage. Furthermore, this drain of power is simply wasteful as it represents unutilized power.

Some existing devices may be inserted in between an outlet and the electronic device's plug, such as, for example the Kill-a-Watt®, which displays to the user how much electricity a device may be using when plugged in. In theory, a user may realize the amount of electricity being used by an electronic device that is turned off However, such a device like the Kill-a-Watt® may present issues. For example, the user may forget to unplug the electronic device in the event that the electronic device is drawing too much energy. Furthermore, the user will likely need to be physically present to turn off the power. As a result, reporting devices such as the Kill-a-Watt® may not be optimal solutions. For example, the Kill-a-Watt® can be costly while having a relatively bulky form factor. In addition, a customer that purchases a Kill-a-Watt® for use will only be able to monitor power consumption for a single device plugged into the Kill-a-Watt®.

Alternatively, many residences come equipped with a power meter which power companies may use to determine the overall power consumption by the residence. However, such power meters are unable to provide details regarding power usage of individual electronic devices or electronic devices as they only provide a lump-sum figure with respect to power usage of the residence.

As a result, a better device for monitoring and controlling power usage of electronic devices is desirable. A device with the functional expandability (e.g., energy monitoring, usage control) and cost scalability (cost directly proportional to the number and complexity of the functions) that can be customized by the users (consumer, OEM, enterprise etc) may be desirable.

### BRIEF DESCRIPTION OF THE DRAWINGS

The accompanying drawings incorporated in and forming a part of the specification illustrate several aspects of the present disclosure, and together with the description serve to explain the principles of the invention; it being understood, however, that the described embodiments are not limited to the precise arrangements shown. In the drawings, like reference numerals refer to like elements in the several views. In the drawings:

FIG. 1 depicts a diagrammatic view of an exemplary embodiment of an intelligent power strip system including mobile access.

FIG. 2 depicts a diagrammatic view of an exemplary embodiment of an intelligent power strip system using a local area network.

FIG. 3 depicts a schematic view of an exemplary embodiment of an intelligent power strip for incorporation with the intelligent power strip systems shown in FIGS. 1-2.

FIG. 4 depicts a schematic view of a sensor of the intelligent power strip shown in FIG. 3.

FIG. 5 depicts a diagrammatic view of a micro-controller unit of the intelligent power strip shown in FIG. 3.

### DETAILED DESCRIPTION

The following description of certain examples should not be used to limit the scope of the present invention. Other features, aspects, and advantages of the embodiments disclosed herein will become apparent to those skilled in the art from the following description, which is by way of illustration, one of the best modes contemplated for carrying out the invention. As will be realized, the embodiments described herein are capable of other different and obvious aspects, all without departing from the invention. Accordingly, the drawings and descriptions should be regarded as illustrative in nature and not restrictive.

### I. Overview

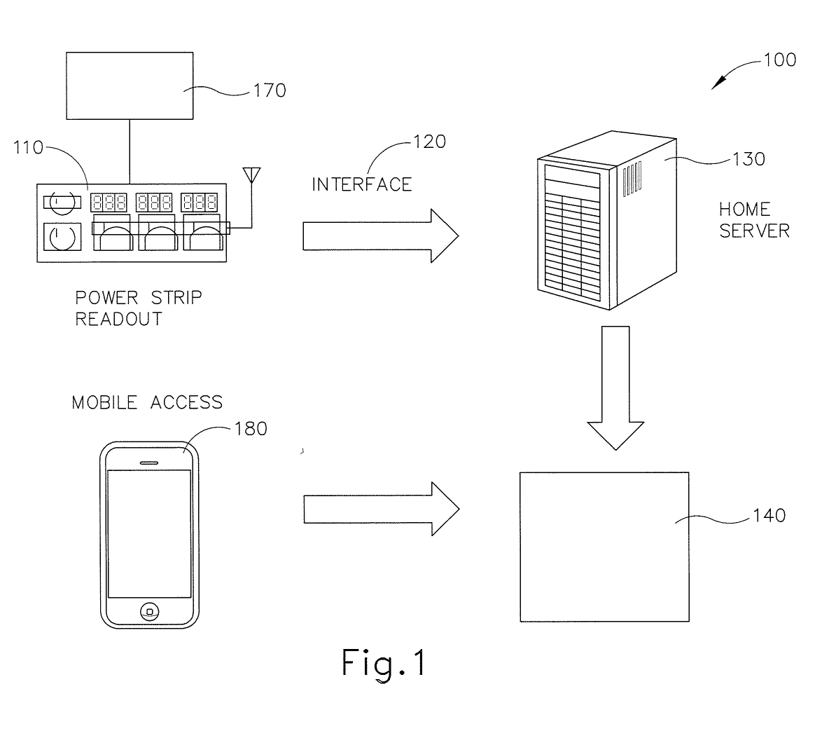

FIG. 1 shows a high level overview of intelligent power strip system (100), which generally comprises electronic device (170), intelligent power strip (110), computer module (130), database module (140), and mobile access device (180). In the exemplary version, electronic device (170) is connected to intelligent power strip (110), where intelligent power strip (110) is connected to a wall outlet or any other suitable source for delivering power. Therefore, intelligent power strip (110) is operable to power to electronic device (170). It will be appreciated that the exemplary embodiment shown in FIG. 1 may be used to provide remote access to intelligent power strip system (100) through mobile access device (180) which may include global access or any other suitable access as would be apparent to one of ordinary skill in the art in view of the teachings herein.

It will be appreciated that in instances where electronic device (170) is connected to, for example, intelligent power strip (110), a generic power strip, or directly to a wall outlet, electronic device (170) may leak electrical power thereby drawing a small amount of power that may amount to significant power drain over a lengthened duration. A way to measure, monitor, and or control this power drain by electronic device (170) may also be desirable. For example, in the event that it is determined that too much power is being used by electronic device (170) connected to intelligent power strip (110), it may be desirable to have intelligent power strip (110) limit further power from being delivered to electronic device (170). Of course, in addition to simply monitoring and controlling leakage current, it may also be desirable to monitor and/or control the power usage of electronic device (170) under normal usage conditions, which the user may use for informational, data mining, or any other suitable purpose.

Electronic device (170) in the illustrated version may comprise any sort of device that may need to be powered. By way of example only, electronic device (170) may include a vacuum, television, refrigerator, any suitable appliance, or any other suitable device as would be apparent to one of ordinary skill in the art in view of the teachings herein. Furthermore, electronic device (170) need not necessarily be limited to a single device. Intelligent power strip (110) may be in communication with multiple electronic devices (170). Electronic device (170) need not be limited to electronic devices that are directly powered by a wall outlet for active usage. Electronic device (170), for example, may also include devices comprising a battery where electronic device (170) is plugged into an outlet for the purpose of charging the battery rather than active use of electronic device (170). It will be appreciated that electronic device (170) may comprise any electronic device (170) that may be plugged into a wall outlet and draw power. Electronic device (170) may further comprise a device and/or appliance that remains essentially constantly plugged in or may comprise a device and/or appliance that is only plugged in for short periods of time. It will further be appreciated that more than one electronic device (170) may be plugged into intelligent power strip (110) for individual monitoring and/or controlling.

In the exemplary embodiment shown in FIG. 1, as electronic device (170) is plugged into intelligent power strip (110), electronic device (170) may draw small amounts of leakage current. It will further be appreciated that information regarding usage of power by electronic device (170) under normal or abnormal usage conditions and/or during the small power drain of the leakage current may be used to limit or monitor the cost to leave electronic device (170) plugged into intelligent power strip (110) over periods of time. Intelligent power strip (110) may also be used to limit or monitor the cost of actively using electronic device (170). Such information may be used to provide the user of electronic device (170) with a better idea regarding relative costs for powering electronic device (170) and may further be used to change the usage of electronic device (170) such that less power is being used by electronic device (170) during active use or when plugged in without being active. Furthermore, intelligent power strip (110) may be designed to change the usage of electronic device (170) as will be described in further detail below. As a result, intelligent power strip (110) in conjunction with intelligent power strip system (100) may be used to monitor and modify the power drawn by electronic device (170) or any other electronic device plugged into intelligent power strip (110). Indeed, intelligent power strip (110) may comprise several plugs such that intelligent power strip (110) can accommodate several electronic devices (170) at once as well as monitor and/or modify the power drawn by the various electronic devices (170) plugged into intelligent power strip (110) independently or in conjunction with each other.

In the illustrated embodiment, intelligent power strip (110) is in communication with computer module (130) through, for example, interface (120). It will be appreciated that interface (120) may comprise a wired and/or wireless interfaces. Furthermore, interface (120) may be operable to switch between a wireless or wired mode. In other merely exemplary embodiments, intelligent power strip (110) may be in communication with computer module (130) through a wired interface, through WiFi communication, through frequency modulation (FM) communication, Bluetooth, through powerline communication interface, or through any other suitable interface as would be apparent to one of ordinary skill in the art in view of the teachings herein. Information collected from intelligent power strip (110) may be transmitted to computer module (130) and/or may be stored on intelligent power strip (110). Computer module (130) may store information transmitted by intelligent power strip (110). Such information might include power usage information reflecting when electronic device (170) is turned off or when electronic device (170) is turned on. Information may include any suitable information as would be apparent to one of ordinary skill in the art in view of the teachings herein. For example, information could include time, power usage, and status of electronic device (170). Additionally, in some embodiments, computer module (130) may analyze and/or store the information, or computer module (130) may transmit information regarding power usage to database module (140). In the illustrated embodiment, computer module (130) is in communication with database module (140). Database module (140) and computer module (130) may be in communication through an internet connection if database module (140) is located remotely. Alternatively, as mentioned above, if database module (140) is not located remotely, database module (140) may be integrated with computer module (130) into a single unit. In some merely exemplary embodiments, database module (140) may be operable to receive information in a one-way manner from computer module (130). However, any suitable transmission or direction of transmission of data may be used as would be apparent to one of ordinary skill in the art in view of the teachings herein. Database module (140) may perform analytical operations on information received from computer module (130), which is received from intelligent power strip (110). Computer module (130) may comprise a display or any other suitable perceivable output device such that computer module (130) can display information regarding power usage to a user. In other exemplary embodiments, rather than a visual display, computer module (130) may provide an audio output to convey usage rates of power by electronic device (170) to a user.

In the merely exemplary embodiment, database module (140) is in further communication with mobile access device (180). It will be appreciated that in some merely exemplary embodiments, mobile access device (180) may be operable to transmit information to database module (140) in one-way communication and accordingly mobile access device (180) may be operable to engage in a read-only interaction with database module (140). Additionally, any suitable direction for transmission of information may be used as would be apparent to one of ordinary skill in the art in view of the teachings herein. Thus, by accessing mobile access device (180), a user can determine the amount of power used by electronic device (170). In the exemplary embodiment, mobile access device (180) may comprise a mobile phone, but may not necessarily be limited to a mobile phone. For example, a computer, laptop, tablet device, or any other suitable device having remote internet access and/or cell network access may be used. For instance, even a public computer or internet café computer may be used to communicate with database module (140). Information from database module (140) may be accessed through, for example, a web interface, or in other exemplary embodiments, information from database module (140) may be accessed through, for example, a dedicated application loaded onto mobile access device (180). Any suitable means for conveying information to mobile access device (180) may be used as would be apparent to one of ordinary skill in the art in view of the teachings herein. Of course, other variations and associations between intelligent power strip (110), computer module (130), database module (140), and mobile access device (180) may be used as would be apparent to one of ordinary skill in the art in view of the teachings herein.

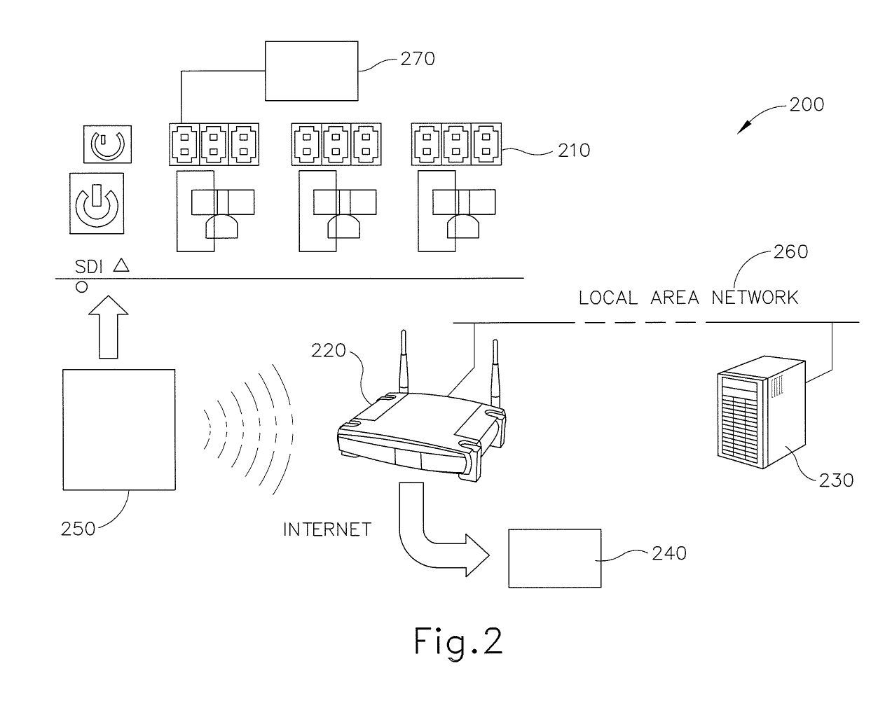

FIG. 2 shows an alternative embodiment of intelligent power strip system (200) comprising intelligent power strip (210) in communication with local area network (260). It will be appreciated that intelligent power strip (210) may be substantially similar to intelligent power strip (110). Local area network (260) is in communication with a database module (240). As a result, intelligent power strip (210) is also in communication with database module (240). Database module (240) may comprise any suitable storage device. For instance, database module (240) may comprise a network attached storage, cloud storage located remotely, or any other suitable storage. Furthermore, database module (240) may be in communication with local area network (260) through a local connection such as over a local network, which may be a wired or wireless connection. Alternatively, database module (240) may be in communication with local area network (260) or computer (230) through an internet based connection. Other suitable methods of connecting database module (240) and router (220) will be apparent to one of ordinary skill in the art in view of the teachings herein. Electronic device (270) is connected to intelligent power strip (210). In the exemplary embodiment shown in FIG. 2, it will be appreciated that communication between intelligent power strip system (210) and local area network (260) involves local connections, intelligent power strip system (200) may be used in a global configuration as shown in FIG. 1.

In the exemplary version, electronic device (270) is plugged into intelligent power strip (210). Further details regarding intelligent power strip (210) will be described below. Intelligent power strip (210) connects to a communication module (250). In the exemplary version, communication module (250) comprises a memory and an input/output interface for writing information to memory. In some exemplary embodiments, communication module (250) may comprise a printed circuit board comprising the above mentioned components including a memory and an input/output interface. Alternatively communication module (250) may comprise any suitable structure as would be apparent to one of ordinary skill in the art in view of the teachings herein such as, for example, a WiFi USB module, a WiFi SDIO module, or a WiFi memory card such as one made by EYE-FI®. Communication module (250) may also be operable to read information from memory. Thus, based on information measured by intelligent power strip (210), intelligent power strip (210) may write the measured information to a memory by using communication module (250). Furthermore, communication module (250) may be used to provide commands to intelligent power strip (210). For example, if the user wishes to limit the amount of total power drawn through intelligent power strip (210), the memory in communication module (250) may have programmed commands to enable such functionality, which communication module (250) can convey to intelligent power strip (210). As a result, rather than simply providing a read-only interface, communication module (250) functions as a write interface as well which is operable to deliver commands to intelligent power strip (210). It will be appreciated that communication module (250) may be operable to provide expandability for intelligent power strip (210). In some exemplary embodiments, communication module (250) may comprise wired/wireless connectivity interface(s) such as WiFi, FM, Bluetooth, Programmable Logic Controller, etc. to a separate computing device. In other merely exemplary embodiments, it will be appreciated that communication module (250) may comprise a memory device for data storage. In other merely exemplary embodiments, it will be appreciated that communication module (250) may comprise one or more processors comprising advanced instructions, programmed intelligent commands, and/or a replacement for a computing module. Other exemplary embodiments may comprise a communication module (250) having any combination of the above mentioned features. For example, in some exemplary embodiments, a memory device for storage may be integrated with a communication device for transmitting or receiving information from the memory device. It will be appreciated that intelligent power strip (210) may comprise casing operable to facilitate wireless communication through communication module (250). For instance, intelligent power strip (210) may comprise a casing lined with metal, metal strips, or portions of metal strips such that intelligent power strip (210) acts as an antenna or antenna booster. Of course, it will be appreciated that intelligent power strip (210) need not be equipped with a metal lined casing.

Communication module (250) in the exemplary version may also function to communicate with local area network (260). As further shown in the exemplary version, local area network (260) comprises computer (230) as well as wireless router (220), which is in communication with computer (230). Communication module (250) is in wireless communication with wireless router (220), which may be established using any sort of wireless communication standard including, but not limited to, the various IEEE 802.11 standards. Furthermore, communication module (250) may be designed to accommodate any further developed standards for wireless communication. While wireless communication is shown in the exemplary version, it will be appreciated that communication between communication module (250) and local area network (260) and/or computer/devices (230) may include wired methods of communication as well or any other suitable means of communication as would be apparent to one of ordinary skill in the art in view of the teachings herein. Additionally, communication within intelligent power strip system (200) may comprise a mix of wired and wireless communication. Furthermore, while a single computer (230) and a single wireless router (220) is depicted, any suitable number of computers and/or similar devices (230) or routers (220) may be used as would be apparent to one of ordinary skill in the art in view of the teachings herein. For example, rather than a single computer (230) several computers and/or devices associated in a home network or a networked computer cluster may be used. Furthermore, while the exemplary version comprises a separate wireless router (220) and computer (230), it will be appreciated that wireless router (220) and computer/device (230) may comprise a single integrated unit.

Having explained the associations between the different components in FIG. 2, generally speaking, electronic device (270) will be plugged into intelligent power strip (210), where intelligent power strip (210) is powered directly by a wall outlet or other suitable power source. Instructions regarding, for example, power usage and power limiting algorithms from computer (230) may be transferred to intelligent power strip (210) by sending the instructions to communication module (250) through wireless router (220). Communication module (250) provides the instructions to intelligent power strip (210) such that intelligent power strip (210) can then use the instructions to control the operation of intelligent power strip (210). Instructions may be preprogrammed or in other scenarios as will be described below, instructions may be programmed by the user for communication to intelligent power strip (210). Power is then delivered from intelligent power strip (210) to electronic device (270) in accordance with the instructions.

### II. Intelligent Power Strip

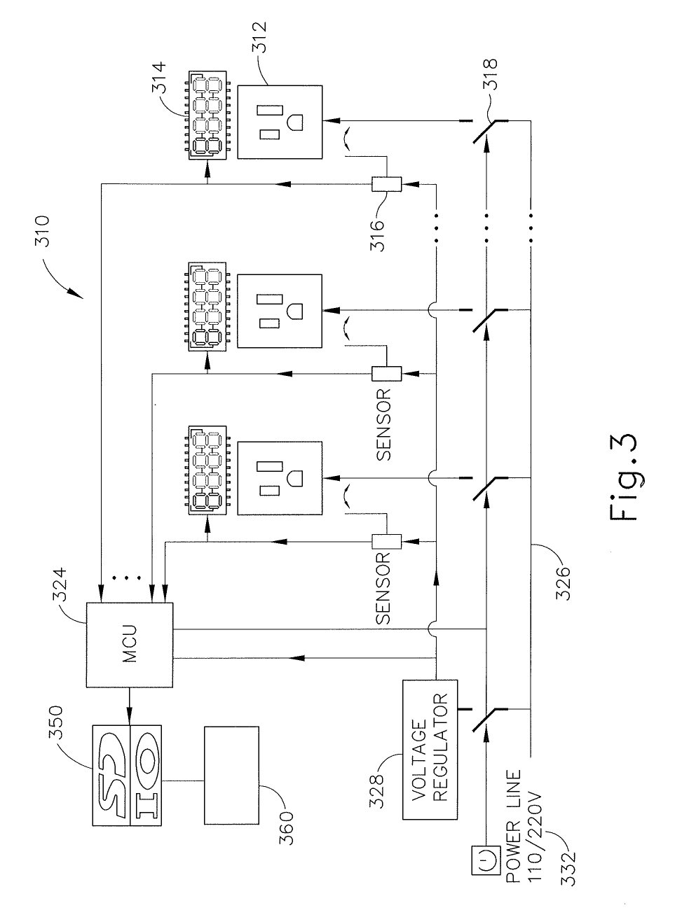

Having discussed generally intelligent power strip system (200), FIG. 3 shows a closer schematic view of a merely exemplary intelligent power strip (310). It will be appreciated that intelligent power strip (310) may be used in place of intelligent power strips (110, 210) shown in FIGS. 1-2. Intelligent power strip (310) comprises at least one plug (312), microcontroller unit (324), input-output (“IO”) interface (350) in communication with a communication module (360), voltage regulator (328), display (314), switch (318), and at least one sensor (316). Switch (318) will be described in further detail below, but it will be understood that switch (318) may be operable to provide better electrical isolation such that switch (318) can stop or greatly reduce leakage current reduction. Furthermore, it will be understood that switch (318) may be operable to have a variety of states including, but not limited to: an opened state, a closed state, a short state, an on state, an off state, any suitable state therebetween, and/or any other suitable states as would be apparent to one of ordinary skill in the art in view of the teachings herein. In some exemplary embodiments, switch (318) may comprise an adjustable resistor such as a rheostat such that switch (318) may be turned on (0 resistance) or off (infinite resistance) as well as set to any adjustment in between on and off. In other exemplary versions, switch (318) may function similarly to, for instance, a water sprinkler rotor speed controller. Other variations for switch (318) may be used as would be apparent to one of ordinary skill in the art.

An electronic device may be inserted into plug (312) thereby allowing intelligent power strip (310) to deliver power to the electronic device. The electronic device may be in some cases similar to electronic device (170, 270) as described in FIGS. 1-2. Furthermore any other suitable electronic device may be used in conjunction with intelligent power strip (310) as would be apparent to one of ordinary skill in the art in view of the teachings herein. In the illustrated embodiment, plug (312) comprises a ground; however, plug (312) need not necessarily include a ground. In some embodiments, intelligent power strip (310) may comprise several plugs (312) such that some of the plugs (312) include a ground whereas others of plugs (312) do not include a ground. The illustrated version also shows three plugs (312) for use with intelligent power strip (310), but any suitable number of plugs (312) may be used as would be apparent to one of ordinary skill in the art in view of the teachings herein. For example, four, five, six, or any suitable number of plugs (312) may be used. Additionally, while the illustrated version depicts plugs (312) arranged linearly, plugs (312) may be oriented in any suitable manner. For example, plugs (312) may be arranged in a circular shape or may be arranged such that plugs (312) are independently movable in relation to one another. Other suitable variations of the arrangement of plugs (312) may be used as would be apparent to one of ordinary skill in the art in view of the teachings herein.

Power line (332) is in electrical communication with plug (312) such that power line (332) is operable to deliver power to plug (312). Power line (332) may be connected to, for example, a wall outlet, a battery, or any other suitable structure from which to draw and deliver power to at least one plug (312). Furthermore, switch (318) is positioned between power line (332) and plug (312). Switch (318) may comprise a closed position and an open position where switch (318) in the open position will not allow power to be transferred from power line (332) to plug (312). When switch (318) is in a closed position, power may be delivered from power line (332) to plug (318).

Switch (318) may further comprise an intermediate position so as to enable a dimmer-like functionality using a potentiometer or other suitable device with respect to the power supplied to plug (312). As shown, power line (332) is also in communication with a voltage regulator (328), which will be described in more detail below. Furthermore, while the illustrated version shows a switch (318) associated with each plug (312), in some versions, it may be contemplated that one or more plugs (312) may share a switch (318) associated with plug (312) such that a single switch (318) may be operable to control multiple plugs (312).

Intelligent power strip (310) further comprises communication module (360) and microcontroller unit (MCU) (324). Communication module (360) of intelligent power strip (310) may be similar or substantially similar to communication module (250) shown in FIG. 2. Communication module (360) may communicate with MCU (324) through IO interface (350). It will be appreciated that IO interface (350) may comprise an SDIO memory card slot, a USB port, or any other suitable interface as would be apparent to one of ordinary skill in the art in view of the teachings herein. Communication module (360) may comprise, for example, a WiFi USB device, a memory card operable to engage an SDIO slot, a combination WiFi and SDIO device, or any other suitable device as would be apparent to one of ordinary skill in the art in view of the teachings herein.

As can be seen in the illustrated version, MCU (324) may be in communication with communication module (360) as well as a sensor (316) and a display (314). MCU (324) is further in electrical communication with voltage regulator (328) to receive power from voltage regulator (328). MCU (324) may comprise pre-programmed and/or user programmed instructions, which may be used to control various components of intelligent power strip (310) as will be described in more detail below. Thus, since MCU (324) is in communication with various components of intelligent power strip (310), MCU (324) can be configured to control the various components of intelligent power strip (310). For example, MCU (324) may be programmed to control the open and close state of switches (318). MCU (324) may be programmed to interface with communication module (360) to write and/or read information to or from a memory card or memory feature in communication with communication module (360). Thus, in an exemplary embodiment, a user could provide programmatic instructions on, for example, a memory card, which could then be used to provide instructions to MCU (324) through communication module (360). Furthermore, MCU (324) may be programmed to receive information from sensor (316) and additionally may be programmed to send information to display (314) for output. In some versions, voltage regulator (328) may comprise a power management unit, which in some instances may be an integrated circuit, but may be any suitable implementation as would be apparent to one of ordinary skill in the art. Voltage regulator (328) may be used generally to provide specific voltage supplies by converting AC voltage to DC voltage or any other suitable voltage output for use by an electronic device. Furthermore, in some versions, voltage regulator (328) may be operable to send information to MCU (324) regarding diagnostic information of voltage regulator (328). It will be appreciated that other variations and uses for MCU (324) will be apparent to one of ordinary skill in the art in view of the teachings herein.

While the illustrated version shows MCU (324) as a separate component from, for example, communication module (360), it will be appreciated that MCU (324) and communication module (360), may be integrated onto a single integrated chip or otherwise suitably integrated. Furthermore, MCU (324) may be integrated with any of the components of intelligent power strip (310) as would be apparent to one of ordinary skill in the art in view of the teachings herein. In some exemplary embodiments, MCU (324) may comprise, for example, a printed circuit board having a computer readable medium where the computer readable medium may be configured to receive a set of programmatic instructions and/or a computer program operable to control the functionality of MCU (324) by executing the computer program.

Display (314) may comprise any suitable display type including, but not limited to, a liquid crystal display (LCD), light emitting diode (LED) display, touch screen display, a graphic and/or text display, an e-ink display, or any other suitable display type as would be apparent to one of ordinary skill in the art in view of the teachings herein. Furthermore, it will be appreciated that display (314) may output any suitable type of information. For example, display (314) may display information regarding the total amount of power (in watts, for example) consumed by a particular plug (312). In other versions, display (314) may be operable to display the power cost in a dollar amount representing the total power consumed by a particular plug (312). In yet other variations, display (314) may be operable to output information regarding the relative power utilization by the electronic device inserted into plug (312) associated with display in relation to power utilization of other electronic devices inserted into other plugs (312) on intelligent power strip (310). Of course, it will be appreciated that other suitable information may be shown by display (314) as would be apparent to one of ordinary skill in the art in view of the teachings herein. For further examples, display (314) may be operable to show operational information regarding intelligent power strip (310) such as general “on” or “off” states of intelligent power strip (310). Display (314) may be operable to mix information types having various combinations of suitable information as would be apparent to one of ordinary skill in the art in view of the teachings herein. For example, display (314) may be operable to output to the user other suitable information such as status of the devices plugged into intelligent power strip (310), timer information, or any other suitable information. In yet other variations, display (314) may be configured to convert wattage information to a dollar amount corresponding to the amount that, for example, a user's power company and/or supplier may charge per watt of power delivered to a consumer. Display (314) may be operable to convey multiple types of information at once or may be operable to convey multiple types of information in a rotating and/or series manner. In some exemplary embodiments, the user may be able to select the information shown on display (314). While the illustrated version shows display (314) as comprising separate displays (314) corresponding to separate plugs (312), it will be appreciated that in some embodiments, a single display (314) may be used to convey information regarding all the plugs (312) of intelligent power strip (310). The information conveyed by such display (314) may comprise aggregate information regarding the power drawn from each or all plugs (312), separate plug (312) information shown on a single display, or may comprise any combination thereof Other suitable ways of conveying information will be apparent to one of ordinary skill in the art in view of the teachings herein.

In the exemplary version, sensor (316) may be operable to measure the amount of power flowing to plug (312). As mentioned earlier, it may be desirable to determine the amount of power used by an electronic device plugged into a particular plug (312) when the electronic device is being used as well as when the electronic device is not in use where a leakage current is causing a small, but substantially continual drain of power. In some versions, it may be desirable to simply report information related to power usage of an electronic device connected to plug (312). In some versions, it may be desirable to actively modify whether power continues to be delivered to plugs (312) by controlling the opening or closing of switch (318) based on predetermined parameters or parameters selected by the user.

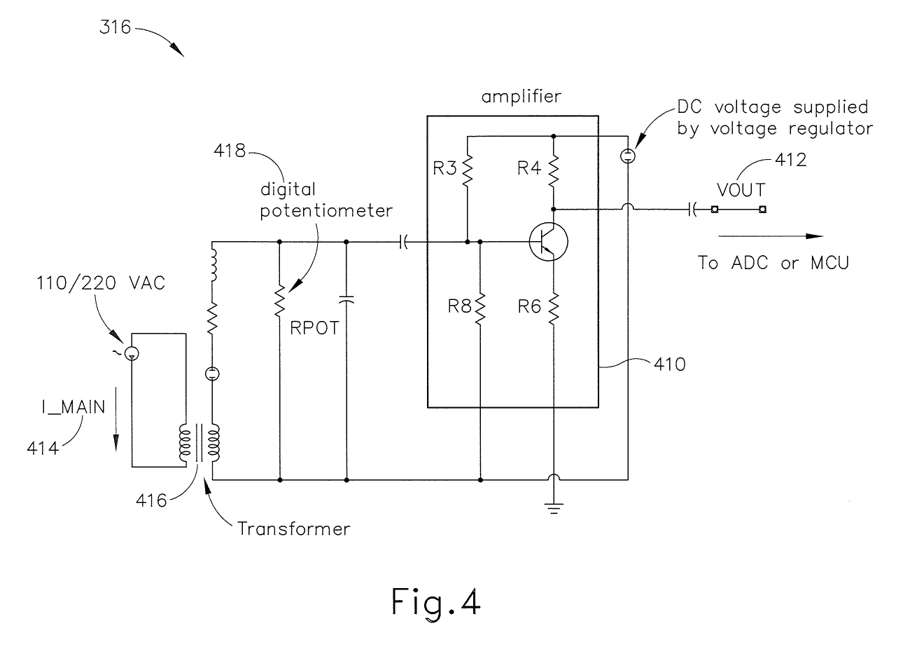

Turning to FIG. 4, a schematic view of sensor (316) of FIG. 3 is shown as a merely exemplary version of the interior of sensor (316). Other suitable circuits and/or designs for sensor (316) will be apparent to one of ordinary skill in the art in view of the teachings herein. As shown, sensor (316) comprises input power line (414) in electrical communication with a transformer (416). Sensor (316) further comprises potentiometer (418) in communication with transformer (416). In the illustrated embodiment, transformer (416) is in communication with amplifier (410), which leads to voltage line out (412). Voltage line out (412) may be in communication with MCU (324), such as one shown, for example, in FIG. 3.

In the illustrated version, electric current travels through the primary side of the transformer (416) into input power line (414) where an electric current is induced at the secondary side of the transformer (416). The resultant signal is then amplified by amplifier (410) where amplifier (410) then sends the resultant amplified signal to voltage line out (412). As shown, because voltage line out (412) is in communication with MCU (324), the amplified signal may then be sent to MCU (324) where MCU (324) can then record the signal information from sensor (316). It will be appreciated that MCU (324) will be able to use the signal information to determine information regarding power used by electronic devices inserted into plug (312). Other suitable uses of the information sent to MCU (324) may be apparent to one of ordinary skill in the art in view of the teachings herein. For example, MCU (324) may be operable to calculate the total wattage consumed by an electronic device inserted into plug (312) of FIG. 3, and then subsequently, MCU (324) may also be operable to transmit that information to communication module (360) such that communication module (360) can write that information to, for example, a memory card. In other versions, communication module (360) may comprise, for example, a wireless transmitter or a combination of a memory card and a wireless transmitter, which may be used to send power usage information to, for example, a computer or other external reporting and/or monitoring device.

Potentiometer (418) may comprise a digital potentiometer or may comprise an analog potentiometer, or any other suitable potentiometer as would be apparent to one of ordinary skill in the art in view of the teachings herein. It will be appreciated that potentiometer (418) may be used generally to adjust the signal input to amplifier (410) such that amplifier (410) operates in an appropriate range.

### III. Using Intelligent Power Strip

Intelligent power strip (110, 210, 310) as shown in FIGS. 1-3 may be used generally to monitor and control the power usage of one or more electronic devices or electronic devices connected to intelligent power strip (310). In a merely exemplary embodiment, a user may connect, for example, a vacuum cleaner, a television, and a lamp to intelligent power strip (310). It will be appreciated that the user may wish to monitor the power usage of the respective electronic devices. In some instances, it will be appreciated that the user may wish to monitor the power usage of the electronic devices collectively, or in other instances, the user may wish to monitor the power usage of the electronic devices separately such that the user may determine the power usage of the electronic devices relative to one another. In yet other instances, the user may wish to monitor the power usage of an electronic device or electronic devices connected to intelligent power strip (310) over a longer period of time, such as days, weeks, and/or months or even years.

Turning now to, for example FIG. 3, upon connecting an electronic device to plug (312), the electronic device may be in an on state, an off state, or a stand-by state. It will be appreciated that the user may wish to monitor and/or control the power usage of an electronic device when it is in one of these states. In the off state, as mentioned above, the connected electronic device may still draw small amounts of power, which the user may be interested in collecting information regarding this drain of power. Thus, even when turned off, a user may be able to determine using intelligent power strip (310) whether a particular electronic device is drawing too much leakage current and hence drawing too much power.

Furthermore, once the user connects one or more electronic devices to intelligent power strip (310), in some instances, intelligent power strip (310) may require no further actions from the user. As electronic devices draw power, such power usage may be detected by sensor (316), which is in communication with MCU (324) which may then write such power usage information to a memory feature in communication with communication module (360). In addition or alternatively, the power usage information may be transmitted via communication module (360) to a computer or other computing device through a wireless communication means for storage and/or reporting of the power usage information. MCU (324), which may be in communication with display (314), may output information regarding the power usage of electronic devices plugged into intelligent power strip (310) such that the user can view such information. For example, the user may look and see that electronic device ‘X’ has used ‘Y’ amount of power since being plugged into intelligent power strip (310). In some merely exemplary embodiments, the user may see such information as shown on display (314), and in other exemplary embodiments, the user may view such information through, for example, a mobile device such as shown in FIG. 1. Furthermore, in other versions, MCU (324) may be programmed to monitor and output to display (314) the amount of power used over a predetermined span of time. For example, display (314) could show the total amount of power used by an electronic device or several electronic devices over the past week or any predetermined time frame. In addition, MCU (324) may be programmed such that certain plugs (312) are assigned to be used specifically with certain electronic devices or may be assigned to specific devices. For example, one of plugs (312) may be assigned to the television such that as MCU (324) continually monitors information from plug (312) assigned to the television. MCU (324) can determine that all power usage information related specifically to the power used by the television. In other instances, one of plugs (312) may be assigned to a vacuum, microwave, refrigerator, or any other suitable appliance. Other variations of assigning plugs (312) to electronic devices will be apparent to one of ordinary skill in the art in view of the teachings herein. As a result, it will be appreciated that intelligent power strip (310) may be used to monitor or control the power usage of particular, individual electronic devices in addition to monitoring the collective usage of power of all the electronic devices inserted into intelligent power strip (310).

Furthermore, MCU (324) may be programmed to control the amount of power consumed through a particular plug (312). For example, by using sensor (316) in conjunction with MCU (324) to monitor the power usage of plug (312), MCU (324) may be programmed such that if the power usage by plug (312) exceeds a certain amount, then switch (318) corresponding to plug (312) may open therefore preventing further draw of power from electronic device connected to plug (312). In some versions, rather than simply cutting off power supplied to an electronic device attached to plug (312) having too much power drawn therefrom, MCU (324) may be programmed to communicate a warning message to display (314). As a result, the user may then view the message on display (314) to know that a particular electronic device is drawing too much power. In other versions, rather than displaying a visual message on display (314) an audio signal can be provided to alert the user that too much power is being drawn from a particular plug (312). Intelligent power strip (310) may also be programmed by the user to provide specific desired functionalities regarding alerts and reporting of intelligent power strip (310).

In some embodiments, it will be appreciated that switch (318) may comprise a rheostat where the rheostat has a variable resistance operable to control the power usage of plug (312) corresponding to switch (318). In some embodiments, switch (318) may comprise a rheostat operable to control the power usage of any number of plugs (312) including some, all, or a single plug. It will be appreciated that the rheostat may be adjusted between having a small resistance, a very large resistance, and any resistance in between. As a result, when the rheostat is adjusted to have a large resistance that approaches infinity, switch (318) becomes effectively open (in an “off” state). When the rheostat is adjusted to have a very small resistance that approaches zero, switch (318) becomes effectively closed or shorted (in an “on” state). Thus, switch (318) may be used to adjust the power usage of intelligent power strip (310) to intermediate states between a fully “on” state and a fully “off” state.

Other variations of a threshold may be used as well. For example, threshold power usage by an electronic device connected to plug (312) may be defined in terms of total power in watts used over the course of a 24 hour period or other suitable window of time. In other versions, the threshold power usage may be defined in terms of average power delivered by plug (312) to an electronic device since the electronic device was connected and/or turned on. In yet other versions, MCU (324) may be programmed to detect the difference between power usages when an electronic device is turned on in comparison to when an electronic device is simply plugged into MCU (324) without being turned on. For example, intelligent power strip (310) may be programmed to store threshold values regarding power usage of electronic devices when the electronic devices are being actively used versus merely plugged in yet still drawing power. In some instances, the threshold power usage may be based on usage statistics of intelligent power strip (310). For example, as intelligent power strip (310) is used, usage statistics may be collected, which can be used to determine probability distributions and times where intelligent power strip (310) is most likely to be used to determine threshold power usages. As a result, threshold power usage settings may be set based on such probability distributions.

The above mentioned threshold values may be used to determine the status of an electronic device connected to intelligent power strip (310). In the event that MCU (324) is used to distinguish between when an electronic device is turned on versus merely plugged in, MCU (324) may be configured to prevent delivery of power to the electronic device when the electronic device is plugged in without being turned on. Upon determining that an electronic device is drawing power without actually being used, MCU (324) can direct switch (318) to open, thereby preventing further power from being delivered to the electronic device. Display (314) may convey to a user that a particular plug (312) has stopped receiving power.

It will be appreciated that in some versions, intelligent power strip (310) may comprise, for example, an override switch such that the user may press or engage the override switch in the event that the user wishes for uninterrupted power to continue to be delivered to the electronic device. For example, intelligent power strip (310) may have erroneously determined that an electronic device connected to intelligent power strip (310) is not being used when in fact, the electronic device is being used. Other variations of overriding decisions made by intelligent power strip (310) may be used as would be apparent to one of ordinary skill in the art in view of the teachings herein. For instance, overriding decisions for intelligent power strip (310) may also include but need not be limited to a system reset function, an MCU (324) reset function, and even the ability to disable any intelligent functions.

In other merely exemplary embodiments, intelligent power strip (310) may contain instructions associated with MCU (324), which enables MCU (324) to control power supplied to plugs (312) based on, for example, a predetermined schedule. In order to carry out a predetermined schedule, MCU (324) may utilize an internal clock contained within MCU (324). It will be appreciated that during certain times of the day, a user may not be present at the location of intelligent power strip (310). For example, a user might be at work and not home during the day. If the user is not at home, it may be desirable to prevent any power from being delivered to electronic devices by intelligent power strip (310). In some merely exemplary embodiments, MCU (324) may be programmed to prevent power from being delivered to any electronic devices plugged into intelligent power strip (310) during specific time periods.

In other exemplary embodiments, MCU (324) may be programmed to prevent power from being delivered to particular plugs (312) according to user preference during certain times of the day. For example, the user may decide that he or she wishes to cut back on power usage during the daytime hours of the day, or the user may wish to cut back on power usage by the television during the day. As such, MCU (324) may comprise programmed instructions to carry out such parameters regarding when power to plugs (312) or particular plugs (312) should be turned on or off In some exemplary versions, MCU (324) may also set an intermediate state between “on” and “off” for delivering power which enables power to plugs (312) to function with a dimmer-like functionality.

Furthermore, in some exemplary embodiments, some of plugs (312) may be designated as “master” plugs where other of plugs (312) may be designated as “slave” plugs such that in the event that “master” plugs are turned off, then “slave” plugs are turned off as well. Furthermore, in the event that “master” plugs are turned on, then power may be turned on for “slave” plugs as well. Other suitable variations for controlling intelligent power strip (310) may be used as would be apparent to one of ordinary skill in the art in view of the teachings herein.

In some exemplary versions, it will be appreciated that MCU (324) may not be operating to monitor and control power delivered by intelligent power strip (310) in a way that satisfies the user, such as if the user has particular needs or schedule not met by the default program. Or in some exemplary instances, the user may desire a particular algorithm to run for determining how to monitor or control intelligent power strip (310). In such cases, it will be appreciated that the user may program MCU (324) such that MCU (324) can control the behavior of intelligent power strip (310) according to the preferences of the user. For example, a user may engage a computer or other computing tool to write, for example, a program, to control the behavior of intelligent power strip (310). In some exemplary embodiments, the user may write such a program using, for example, a software developer kit included with intelligent power supply (310). In other versions, the user may use a program on, for example, a computer that is designed to streamline the process of programming MCU (324).

The program may be configured to accept input from the user including information regarding times of the day, days of the week, limits regarding how much power is to be delivered from intelligent power strip (310), what electronic devices are connected to which plugs (312), or any other suitable information as would be apparent to one of ordinary skill in the art in view of the teachings herein. Once the information is received from the user, the program can construct instructions for MCU (324), which can be transferred to MCU (324) through communication module (360). MCU (324) can then carry out the instructions provided to control the behavior of intelligent power strip (310) based on the parameters provided by the user. It will be appreciated that in some versions, intelligent power strip (310) can be further programmed by the user to have the above mentioned programmability through use of a separate module that may be added or removed from intelligent power strip (310). In other versions, all of the above mentioned features regarding programmability of intelligent power strip (310) may simply be integrated into intelligent power strip (310) such that pre-programmed behaviors are included as well as the ability to have user programmed behaviors.

Since, as mentioned above, communication module (360) may comprise wireless and/or network connectivity, it will be appreciated that a user may remotely control the behavior of intelligent power strip (310). For example, if the user is at work or some other remote location, the user may be able to access communication module (360) directly or indirectly through a program and/or internet interface, configured to allow the user to change the behavior of intelligent power strip (310). In some versions, in addition to modifying the behavior of intelligent power strip (310), user may access communication module (360) to simply obtain reporting information regarding intelligent power strip (310) and power usage by some, all, or any combination thereof of plugs (312).

It will be appreciated that intelligent power strip (310) may be used as a platform for further expandability by a user, who may provide programmatic instructions to MCU (324) to modify or add to the functionality of intelligent power strip (310). For example, the user may wish to customize functionality beyond what intelligent power strip (310) is operable to do by default. In some exemplary embodiments, communication module (360) may comprise one or more connectors by which the user may interface with MCU (324) through communication module (360) to add desired functionality, which may be achieved by connecting additional hardware components to communication module (360) through the connectors. For example, in some exemplary embodiments, the user may communicate instructions to MCU (324) through a GUI enhanced program on a computer which may be used to select or customize functionality for intelligent power strip (310). In some other exemplary embodiments, the user may provide instructions to MCU (324) at a more fundamental level by writing programmatic instructions in a programming and/or scripting language that may be loaded directly onto MCU (324) or otherwise communicated to MCU (324) for MCU (324) to use.

It is contemplated that intelligent power strip (310) may include hardware expandability in addition to software expandability as described above. For instance, intelligent power strip (310) may be in selective communication with additional memory card(s), WiFi USB devices, various other plug and play devices, or any other suitable devices operable to expand functionality of intelligent power strip (310) as would be apparent to one of ordinary skill in the art in view of the teachings herein. It will also be appreciated that intelligent power strip (310) may be operable to serve as a flexible platform for future expansion such other hardware and software aspects may be developed for intelligent power strip (310) such that intelligent power strip (310) may have added functionality.

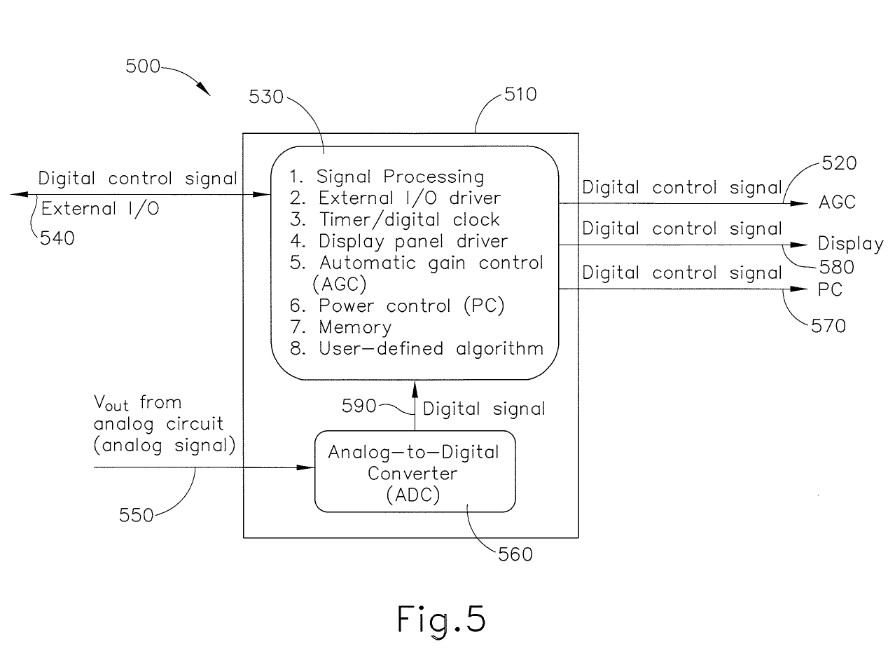

FIG. 5 shows an enlarged diagrammatic view of MCU (500), which may be substantially similar to MCU shown in FIG. 3. MCU (500) comprises body (510), which has functions including, but not limited to, processor (530) and analog-to-digital converter (560). Processor (530) and analog-to-digital converter (“ADC”) (560) are in communication with each other through digital signaling (590), but any suitable means of communication may be used as would be apparent to one of ordinary skill in the art in view of the teachings herein. Furthermore, in some exemplary embodiments, processor (530) and ADC (560) may be integrated onto a single chip or any other suitable configuration. ADC (560) is operable to convert an analog signal into a digital signal for use by processor (530).

Processor (530) comprises various functionalities including, but not limited to, pre-defined signal processing, an external input/output driver (which may comprise, for example, software, firmware, or other executable instructions operable to control external hardware such as, but not limited to WiFi USB device(s), an SDIO memory card, or any other suitable device), a timer and/or digital clock, a display panel driver, an automatic gain control (“AGC”), memory, and/or a user-defined algorithm. In other exemplary embodiments, other functionalities may be added or removed from processor (530) as would be apparent to one of ordinary skill in the art in view of the teachings herein. In yet other exemplary embodiments, various functionalities of processor (530) may be modified by a user. For example, the user-defined algorithms on processor (530) may be modified by external programming by a user according to desired needs of the user. Other modifications to processor (530) may be used as would be apparent to one of ordinary skill in the art in view of the teachings herein.

AGC line (520) is in communication with processor (530) and is operable to generally to provide a feedback signal to the automatic gain control on processor (530). Analog signal line (550) is in communication with ADC (560) and in further communication with sensor as shown in FIG. 3. Analog signal line (550) is operable to deliver output voltage signal from sensor to analog-to-digital converter. Display line (580) is in communication with display panel driver on processor (530). Display line (580) is further in communication with a display such as display depicted in FIG. 3. Accordingly, display line (580) is operable to transmit information from processor (530) to display thereby allowing the user to view relevant information regarding intelligent power strip. Power control line (570) is in communication with processor (530) and is in further communication with outlets and/or switches of intelligent power strip as shown, for example, in FIG. 3. Accordingly, power control line (570) is operable to transmit signals from processor (530) to control switches to prevent power from being delivered to electronic devices connected to intelligent power strip and/or to allow power to be delivered to the devices based on the programmed functionality or algorithms of intelligent power strip.

Digital control signal line (540) is in communication with processor (530) and may be used to engage an external input/outline interface such as a wireless module or a memory card. In other exemplary embodiments, digital control signal line (540) may be used to interface with any suitable module as would be apparent to one of ordinary skill in the art in view of the teachings herein. As a result of being able to engage external input/output interfaces, it will be appreciated that digital control signal line (540) may be operable to provide expanded functionality to intelligent power strip by interfacing with various external devices. Other suitable uses for digital control signal line (540) will be apparent to one of ordinary skill in the art in view of the teachings herein.

In addition to parts shown in FIG. 5, it will be appreciated that MCU (500) may be expandable through various hardware features. For example, MCU (500) may comprise additional expandability slots and/or sockets operable to interface with an SDIO memory card and/or any other suitable devices for expanding functionality or capabilities of MCU (500) as would be apparent to one of ordinary skill in the art in view of the teachings herein.

Having shown and described various embodiments in the present disclosure, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. An apparatus for monitoring power comprising:
(a) a plurality of plugs, wherein each of the plurality of plugs is configured to provide electrical power to a device;
(b) at least one sensor in communication with the plurality of plugs, wherein the at least one sensor is configured to monitor current flowing to the plurality of plugs; and
(c) at least one microcontroller unit in communication with the at least one sensor, wherein the at least one microcontroller unit is configured to receive readings from the at least one sensor regarding the amount of current delivered to the plurality of plugs.

2. The apparatus of claim 1, further comprising an input-output device, wherein the at least one microcontroller unit is in communication with the input-output device.

3. The apparatus of claim 2, wherein the at least one microcontroller unit is configured to write or read information to an external memory through the input-output device.

4. The apparatus of claim 1, further comprising a voltage regulator in communication with the at least one sensor, wherein the voltage regulator is in further communication with the at least one microcontroller.

5. The apparatus of claim 1, further comprising a plurality of switches in communication with the plurality of plugs, wherein the at least one microcontroller is in communication with the plurality of switches, wherein the at least one microcontroller is configured to control the opening and closing of the plurality of switches.

6. The apparatus of claim 1, wherein the at least one microcontroller unit is in communication with a local area network, wherein the local area network is in communication with a storage device.

7. The apparatus of claim 6, wherein the storage device is configured to be accessed using a mobile device.

8. The apparatus of claim 1, further comprising a plurality of displays in communication with the at least one microcontroller, wherein the at least one microcontroller unit is configured to update the plurality of displays.

9. The apparatus of claim 8, wherein the at least one microcontroller is further configured to calculate the total number of watts delivered to the plurality of plugs, wherein the at least one microcontroller is configured to display the number of watts delivered to the plurality of displays.

10. The apparatus of claim 8, wherein the plurality of displays are configured to switch the type of information displayed on the plurality of displays.

11. The apparatus of claim 1, wherein the at least one sensor is configured to amplify an input signal for communication with the at least one microcontroller unit.

12. The apparatus of claim 1, wherein the at least one microcontroller unit is in selective communication with a computer, wherein the at least one microcontroller unit comprises a computer readable medium operable to carry out a set of instructions provided by the computer, wherein the set of instructions is configured to be user programmable.

13. The apparatus of claim 1, wherein the at least one microcontroller unit is in wireless communication with at least one computer, wherein the at least one microcontroller unit is configured to send and receive information wirelessly to the at least one computer.

14. The apparatus of claim 13, wherein the at least one computer is configured to be in further communication with a mobile device, wherein the at least one computer is configured to provide information to the mobile device.

15. The apparatus of claim 1, wherein the mobile device comprises a smart phone configured to process information from the at least one computer.

16. A system for monitoring power comprising:
(a) a server computer;
(b) a mobile device in communication with the server computer, wherein the mobile device is configured to send and receive information from the server computer;
(c) a power strip, wherein the power strip is configured to plug into a wall outlet to receive power, wherein the power strip comprises at least one plug configured to deliver power, wherein the power strip is configured to measure the amount of power delivered through the at least one plug, wherein the power strip is configured to measure power leakage through the at least one plug, wherein the power strip is configured to transmit the power leakage of the at least one plug to the server computer.

17. The system of claim 16, wherein the power strip is in wireless communication with the server computer.

18. The system of claim 16, wherein the power strip comprises at least one microcontroller configured to be programmable, wherein the at least one microcontroller is configured to be reprogrammed.

19. The system of claim 16, wherein the power strip is configured to selective turn off power delivered to the at least one plugs.

20. A method for monitoring power using an intelligent power strip, wherein the intelligent power strip comprises a microprocessor, at least one switch, at least one sensor, and at least one plug operable to deliver power, the method comprising:
(a) delivering power to the at least one outlet;
(b) programming the microprocessor;
(c) measuring the power delivered to the at least one plug, wherein the act of measuring is carried out using the at least one sensor; and
(d) selectively switching off the power delivered to the at least one plug, wherein the act of selectively switching off the power is performed by the microprocessor controlling the at least one switch.
